(19) United States
(12) Patent Application Publication
(10) Pub. No.: US 2010/0194985 A1
(43) Pub. Date: Aug. 5, 2010

(54) METHOD AND SYSTEM FOR DISPLAYING A WIRELESS CHANNEL SPACE ON A DISPLAY DEVICE

(75) Inventors: Robert Unger, El Cajon, CA (US); James R. Milne, Ramona, CA (US)

Correspondence Address: SONY C/O MURABITO, HAO & BARNES LLP, TWO NORTH MARKET STREET, THIRD FLOOR, SAN JOSE, CA, 95113, US

(73) Assignees: Sony Corporation, Tokyo (JP); Sony Electronics, lnc., Parkridge, NJ (US)

(21) Appl. No.: 12/363,606

(22) Filed: Jan. 30, 2009

(51) Int. Cl. H04N 5/50; H04B 17/00; H04B 7/00

(52) U.S. Cl. 348/570; 455/67.11; 455/66.1

(57) ABSTRACT

Embodiments of the present invention are directed to provide a method and system for the generation and display of a channel space state for a band of frequencies in a wireless display device. One novel method enables the display of a channel space state by continuously or repeatedly scanning, in a remote wireless transceiver, a channel space to determine a channel space state. The channel space state is communicated to the wireless display device. When interference for the channel used to transmit content to the wireless display device is detected during a scan, a graphical representation of the channel space state is displayed in the wireless display.

### BACKGROUND

The proliferation of wireless technology and wireless devices has increased exponentially in recent years, and are now utilized in a number of applications to achieve advantageous results. A recent development in the field of wireless application is the employment of wireless technologies to deliver content to remote displays (e.g., flat panel televisions) in real time.

Typical wireless data transmissions performed between wireless (and wireless compatible) devices are conducted according to IEEE 802.11, a set of standards for wireless local area network (WLAN) computer communication transmitted over ultra-high frequency or super high frequency radios waves in public spectrum bands, such as the Industrial, scientific and medical (ISM) bands. Popular bands include the 2.4 GHz band (2.400 GHz-2.500 GHz) and the 5.8 GHz (5.725 GHz-5.875 GHz) band. The 802.11b/g/n standards divide each of these bands into a multitude of channels. For example, the 2.4 GHz band is divided into 3 channels, each of width 22 MHz and spaced 25 MHz apart.

However, the types of signaling protocols used by devices in the public spectrum (e.g., unlicensed) bands are not designed to cooperate with signals of other types also operating in the same bands. Thus, a wireless device will share the same spectrum with other wireless devices utilizing the unlicensed bands. Wireless pollution occurs when an excessive number of wireless data transmitting devices congest within a shared range of the devices, especially on the same or neighboring channel(s). Wireless pollution can prevent access to and interfere with the use of other wireless devices. This can be a problem in areas with a high density of wireless devices. In addition, many 2.4 GHz wireless devices default to the same channel initially, contributing to extreme congestion on certain channels. Changing the channel of operation often requires the user to manually configure the device.

Even worse, other non-WiFi enabled devices or systems, such as microwave ovens, security cameras, baby monitors and cordless telephones, etc., may emit energy in certain channels of the unlicensed bands. It is quite possible for these devices to interfere with each other and cause degradation in signal strength or a loss in data transmission fidelity. Accordingly, as the density of wireless devices rises to correspond to the growth in popularity and versatility of wireless applications, the likelihood of interference and its accompanying effects also rises.

A conventional solution to this problem has been for manufacturers of wireless technology devices to simply tune a wireless technology device to transmit data in higher frequency bands in the spectrum. For example, early generations of cordless phones used the 46-49 MHz bandwidths. However, since many devices also emitted low-band interference in this range (e.g., refrigerators, TVs, and computers), the clarity and range of cordless conversations were often subject to diminished quality. Additionally, baby monitors and low-band pagers also crowded these same frequencies. In response, the FCC opened up the 900 MHz range.

The popularity of 900 MHz cordless phones led to extreme channel congestion and privacy concerns, since users could often overhear conversations from neighboring cordless phones. Due to this congestion, the FCC opened up yet another range of frequencies: the 2.4 GHz band. Though this frequency was new for phones, the 2.4 GHz band was also being used for wireless LANs. Additionally, microwave ovens emit transmissions in the 2.4 GHz band. Recently, 5.8 GHz was introduced as an available public frequency band.

However, as the prevalence of wireless devices increases even further, the scarcity of available channels will extend to the 5.8 GHz band as well and a similar problem will inevitably arise. Furthermore, higher frequency bands may have less appealing technical characteristics (e.g., decreased distances for signal propagation and an inability to penetrate surfaces). Moreover, devices operating in a higher frequency band may have a higher cost relative to corresponding devices operating in a lower frequency band.

Another solution for persistent wireless interference is to use spectral analysis to determine the source(s) of interference. Wireless devices (e.g., access point hardware) can be installed at or near the point of interference to “jam” an interfering signal so as to avoid further interference. Alternatively, software may be executed on wireless computing devices (e.g., a laptop) that can detect causes of wireless interference. Once wireless interference has been detected, a wireless device may be re-positioned so as to be further from the source of interference, so as to mitigate the effects of the interference.

However, currently available spectrum analyzer devices are specialized equipment that are often extremely expensive, and require special technological expertise to use and understand. Moreover, the additional costs of using one or more wireless jamming devices may become prohibitively expensive for a consumer. Likewise, spectrum analysis applications require a computing platform (e.g., a laptop) to execute on, which may represent an additional investment (e.g., both the laptop itself as well as the software) on the part of the consumer.

Furthermore, as the use of wireless technologies to deliver content to remote displays (e.g., flat panel televisions) in real time increases, the ability to both analyze a spectrum for interference as well as to configure both a wireless display device as well as the wireless content provider becomes of paramount importance. Applying conventional solutions for spectral analysis may detect interference successfully, but, due to the static nature of wall-mounting and the weight and dimensions of a typical flat-panel display or any large display device, relocating the display device may not be a practical option for mitigating interference on a channel.

### SUMMARY

Embodiments of the present invention are directed to provide a method and system for the generation and display of a graphical representation of a channel space state for a band of frequencies in a display device, e.g., a wireless display device.

One novel method enables the display of a channel space state by detecting, in a remote transceiver, interference in a channel space which is transmitted and displayed in a wireless display device.

Another novel method provides the ability to detect and display a channel space state in a wireless display device directly.

Each of the above novel methods provide for the display of a graphical representation of a channel space in a wireless display device to enable a user to intuitively view and configure the input frequency in the channel space so as to advantageously avoid and/or mitigate interference in the channel space state.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a graphical representation of an exemplary configuration of a plurality of wireless devices for displaying a channel space state, in accordance with embodiments of the present invention.

FIG. 2 depicts a graphical representation of an exemplary arrangement for displaying a channel space state in a wireless display device, in accordance with embodiments of the present invention.

FIG. 3 depicts a graphical representation of an exemplary display of observable noise in a channel space state, in accordance with embodiments of the present invention.

FIG. 4A depicts a graphical representation of an exemplary display of channel occupancy in a channel space state, in accordance with embodiments of the present invention.

FIG. 4B depicts an alternate graphical representation of an exemplary display of channel occupancy in a channel space state, in accordance with embodiments of the present invention.

FIG. 5 depicts a flowchart of an exemplary computer-controlled process performed in a transmitter unit for automatically displaying channel space interference in a wireless display device, in accordance with embodiments of the present invention.

FIG. 6 depicts a flowchart of an exemplary computer-controlled process performed in a transmitter device for manually displaying channel space interference in a wireless display device, in accordance with embodiments of the present invention.

FIG. 7 depicts a flowchart of an exemplary computer-controlled process for scanning a channel space state, in accordance with embodiments of the present invention.

FIG. 8 depicts a flowchart of an exemplary computer-controlled process performed in a wireless display device for automatically displaying a channel space state in a wireless display device, in accordance with embodiments of the present invention.

FIG. 9 depicts a flowchart of an exemplary computer-controlled process performed in a wireless display device for manually displaying a channel space state in a wireless display device, in accordance with embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known processes, procedures, components, and circuits have not been described in detail as not to unnecessarily obscure aspects and features of the subject matter.

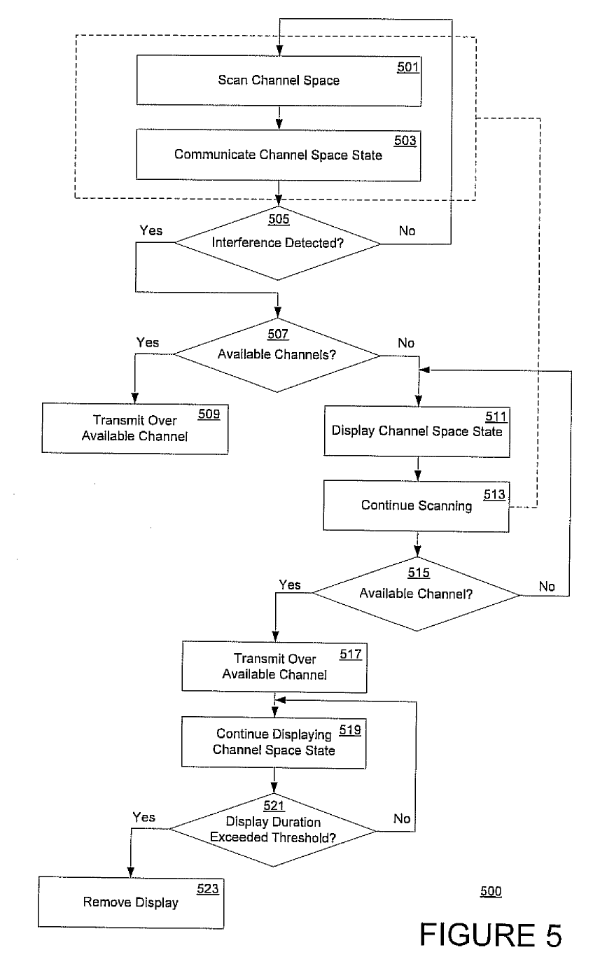

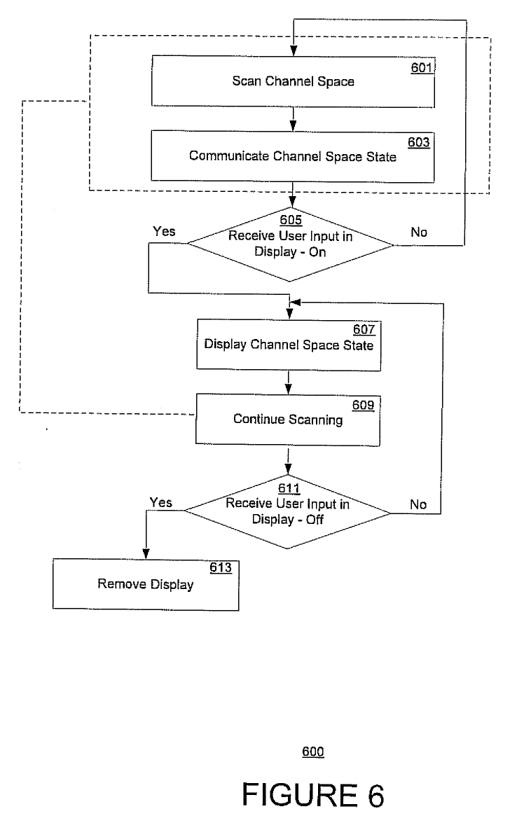

Portions of the detailed description that follow are presented and discussed in terms of a process. Although steps and sequencing thereof are disclosed in a figure herein (e.g., FIGS. 5-6) describing the operations of this process, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

While the following exemplary configurations are shown as incorporating specific, enumerated features and elements, it is understood that such depiction is exemplary. Accordingly, embodiments are well suited to applications involving different, additional, or fewer elements, features, or arrangements.

In a typical wireless system, a majority of data primarily flows in one direction, from a transmitter device to a receiver device. However, it is often the case that each wireless device in the system actually functions as a transceiver which transmits data in either: the “downstream” channel (primary) or the “upstream” or “back” channel (secondary). For the sake of clarity, and in order to more easily distinguish between the roles of each wireless device in a system, they will be described from now on by their primary function, either as a transmitting unit (e.g., a “transmitter”) or as a receiving unit (e.g., a “receiver”).

### Exemplary Wireless Device Configuration

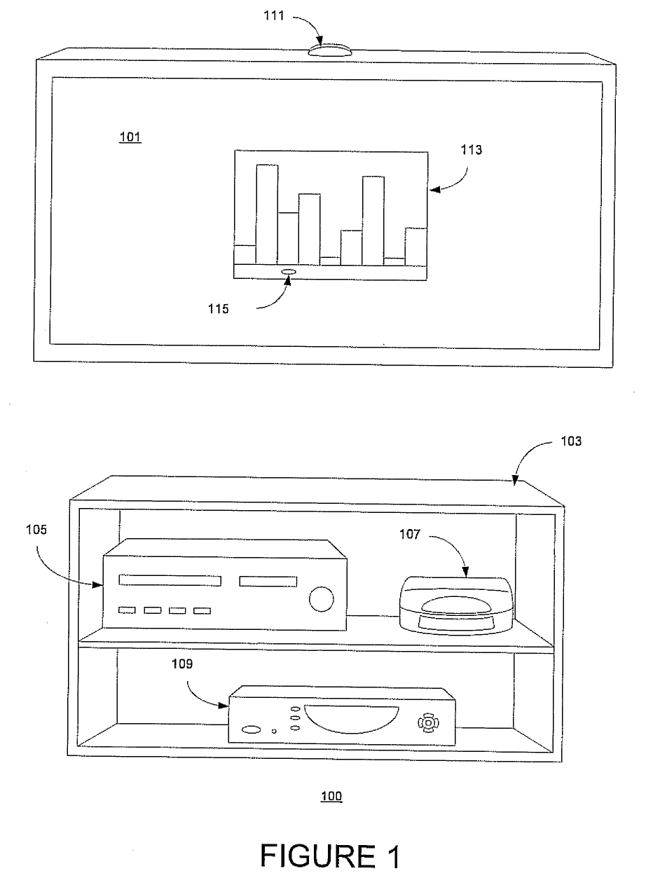

With reference now to FIG. 1, a graphical representation of the display of the energy presence in a spectral (frequency) space of interest in an exemplary configuration 100 of a plurality of wireless devices is depicted, in accordance with embodiments of the present invention. A spectral space of interest is typically divided into different channels, wherein each wireless system tends to occupy one channel at a time. As presented, configuration 100 includes a display device 101, peripheral devices (e.g., audio device 105 and cable box 109) and a transmitter 107.

As presented, exemplary configuration 100 depicts a display device 101. In one embodiment, display device 101 is a television or monitor operable to display input received wirelessly. In further embodiments, display device 101 is a flat-panel television. According to one aspect, display device 101 receives input wirelessly via a receiver (e.g., receiving unit 111) receiving data transmitted over a radio frequency in the industrial, scientific and medical radio bands (ISM bands). In further embodiments, the data is transmitted according to IEEE 802.11 protocols (e.g., 802.11n). As presented, receiving unit 111 is depicted as disposed atop the frame of display device 101. In alternate embodiments, receiving unit 111 may be disposed entirely within the frame of display device 101, so as to be visually obscured when viewed from an external location.

As depicted, configuration 100 includes peripheral devices, such as audio device 105 and cable box 109. As presented, peripheral devices, e.g., audio device 105 and cable box 109 as well as transmitter 107 are depicted as stored in a storage unit 103. In one embodiment, cable box 109 may, for example, comprise a cable converter box which converts a plurality of available channels from a cable television service to a radio frequency signal on a single channel. In a further embodiment, a transmitter 107 communicatively coupled to the cable box receives the radio frequency signal which may be wirelessly transmitted to the receiver 111 and displayed in display device 101. In one embodiment, the transmitter is a set-top box (STB) or set-top unit (STU) that connects to a television and an external source of signal (e.g., the cable box 109, or direct line to a cable source), turning the signal into content which is then displayed on the display device. Cable box 109 may also be implemented as, for example, a satellite television receiver. In further embodiments, the cable box 109 may have a device or application functioning as a transmitter incorporated, and a separate transmitter unit 107 may not be necessary.

In one embodiment, input received from the transmitter 107 (or, alternatively, in a cable box 109 with transceiving functionality) from a cable or satellite television service is wirelessly transmitted to the wireless display device 101 via a select frequency channel of a band of frequencies (e.g., 5.8 GHz ISM band). When service (e.g., the transmission of data) is interrupted, by, for example, interference in the transmission frequency, or by user request, the band of frequencies may be scanned and a graphical representation of the current channel state of the band of frequencies may be displayed in the wireless display device 101.

As shown in FIG. 1, graphical display 113 may be depicted as a plurality of nodes, each node representing a channel in the available band of frequencies. In one embodiment, occupancy for the band of frequencies is distinguished by visible indicia. For example, available channels (e.g., unoccupied or relatively unoccupied channel) may be distinguished from unavailable channels (e.g., occupied or relatively occupied channels) by color (e.g., an available channel is presented in a color dissimilar to the color of an unavailable channel), or other visual attributes. Other visible indicia may include, but are not limited to, specific denotation of available and unavailable channels.

In one embodiment, graphical display 113 also comprises an indicator 115 indicating the current channel being received by the receiver 111 and displayed in the display device 101. In still further embodiments, graphical display 113 is operable to receive input to change the current frequency channel being received by the receiver 111 and displayed in the display device 101 to another channel in the band.

In one embodiment, the channel space is continuously scanned for occupancy by the transmitter 107 and/or the receiver 111. In further embodiments, the channel space may be communicated or synchronized between the two devices at pre-set or variable intervals. For each scanning iteration, the channels in the channel space are scanned. In some embodiments, the channels may be scanned in sequential order. Each channel is scanned to detect occupancy or interference in the channel. The state of the scanned channel is subsequently used to update data comprising the state of the entire channel space, (e.g., in a channel table). In some embodiments, this data may be stored in, for example, a memory module or unit at one of or both the transmitter 107 and the receiver 111. Accordingly, a user may reference a display of the channel space to select a channel with less (or no) interference to broadcast and receive wireless input. In one embodiment, a user may be able to manually select a frequency channel via a remote control unit associated with the display 101. In alternate embodiments, a user may be able to manually select a frequency channel through a console or interface disposed on an external surface of the display device 101 and/or transmitter 107.

In one embodiment, a user may be able to select from a pair of modes of channel selecting operation (e.g., “automatic” and “manual”). Under manual operation, the selection of the frequency channel to be received as input and displayed may be performed by the user as described above, either through an interface on the display, or via a remote control unit. Alternatively, during automatic operation, the selection of the frequency channel to be received as input and displayed may be performed automatically by the transmitter 107 and/or the receiver 111. For example if, during automatic operation, interference is detected in the channel used to transmit the input data between the transmitter 107 and the receiver 111, each device may automatically select to transmit and receive, respectively, the channel with the lowest amount of detected interference, based on the latest data for the channel space. The channel with the lowest amount of detected noise may be determined by, for example, a simple heuristic.

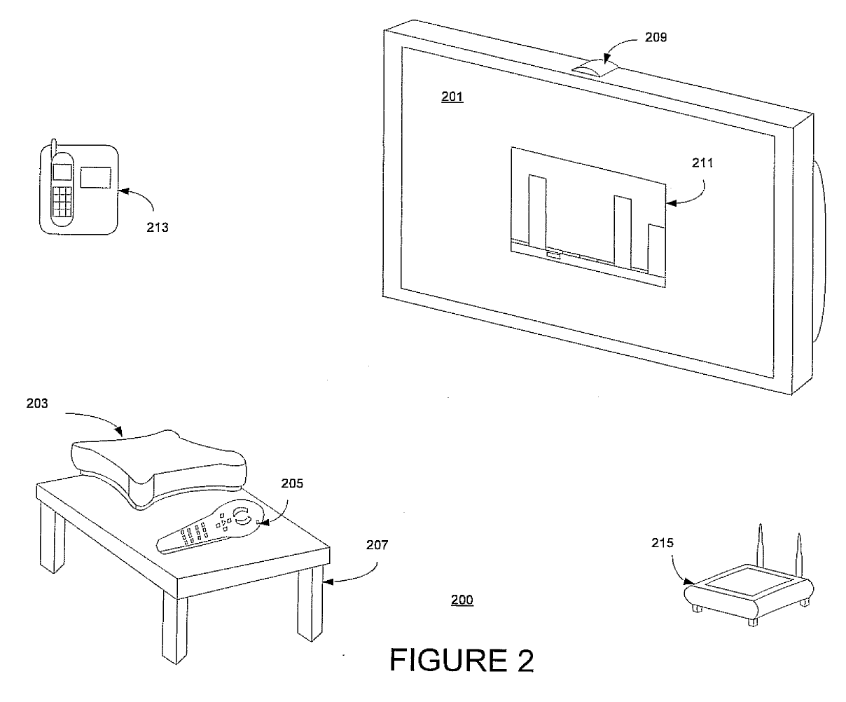

With reference now to FIG. 2, a graphical representation of an exemplary arrangement 200 for pro-actively displaying a channel space state is depicted, in accordance with embodiments of the present invention. In a typical configuration, arrangement 200 includes a flat-panel television 201, set-top box 203, remote control unit 205 and potentially interfering devices (e.g., cordless phone 213, wireless router 215).

As depicted in arrangement 200, flat-panel television 201 may be positioned remotely from set top box 203. Flat-panel television 201 may, for example, be the wireless display device 101 as described above with reference to FIG. 1. In some embodiments, flat-panel television 201 communicates with set top box 203 wirelessly, over one or more radio frequency channels. In one embodiment, set top box 203 may, for example, be a cable box 109 with transceiving functionality, as described above with reference to FIG. 1.

In one embodiment, input received in the set-top box 203 from a cable or satellite television service is wirelessly transmitted to a receiver 209 communicatively coupled to the flat-panel television 201. The input may be transmitted from the set-top box 203 to the receiver 209 via a select frequency channel of a band of frequencies (e.g., 5 GHz band). When interference in the transmission frequency is detected, a graphical representation of the current channel space state of the band of frequencies may be displayed in the flat-panel television 201 automatically or by manually (e.g., by user prompt via the remote control unit 205). As shown in FIG. 2, on-screen graphical display 211 may be depicted as a bar graph indicating the channels of a band of frequencies and the corresponding noise (e.g., possible interference). In a further embodiment, graphical display 213 also comprises an indication of the current channel being received by the receiver 209 and displayed in the flat-panel television 201.

In one embodiment, display 201 (via receiver 209) is operable to receive input to change the current channel being received by the receiver 209 and displayed in the flat-panel television 201 to another channel in the band. Accordingly, a user may be able reference the graphical display 211 of the current channel space state to select a channel with less (or no) interference to broadcast and receive wireless input, in response to interrupted service or poor display quality, for example. In one embodiment, a user may be able to select a frequency channel via a remote control unit 205. In further embodiments, the frequency channel selection may be performed automatically as described above with reference to FIG. 1.

Alternatively, a user may use the graphical display 211 of the current channel space state to view the effect to a channel space from adding one or more potentially interfering wireless devices (e.g., cordless phone 213, wireless router 215) for the purposes of preventing or mitigating spectrum interference or other diagnostic tasks in the wireless environment. For example, a user attempting to add a cordless phone 213 and a wireless network router 215 is able to view, via the display 201, the effect (if any) to the traffic in the channel space. Specifically, an increase in the traffic in the wireless environment may be viewed in graphical display 211, such as through a rise in the level of interference detected in a channel in the spectrum when the added devices are fully powered and operating normally.

### Channel Space State Representation

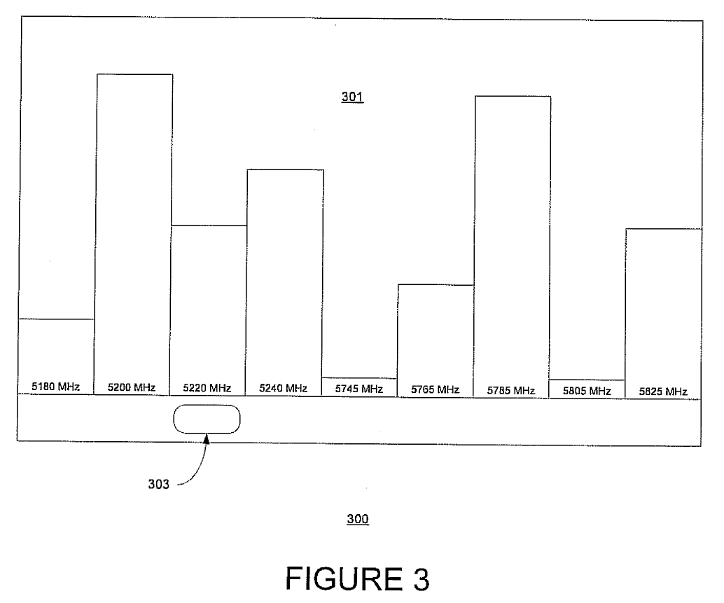

With reference now to FIG. 3, a graphical representation of an exemplary display 300 of observable noise in a channel space state is depicted, in accordance with embodiments of the present invention. Display 300 may, for example, comprise the graphical representation of the channel space state (e.g., graphical display 113, 211) displayed in a display device (e.g., wireless display device 101, flat-panel television 201) of FIGS. 1 and 2.

As depicted in FIG. 3, display 300 comprises a bar graph 301 displaying the plurality of frequency channels (e.g., 5180 MHz, 5200 MHz, 5220 MHz, 5240 MHz, 5745 MHz, 5765 MHz, 5785 MHz, 5805 MHz, 5825 MHz) in a band of frequencies (e.g., 5.8 GHz ISM band) arranged horizontally in sequential fashion. In one embodiment, the level of interference detected in a frequency channel may be represented by the height of a bar corresponding to the frequency channel. Thus, a frequency with a taller bar indicates a higher level of detected interference relative to a frequency displayed with a shorter bar. In an alternate embodiment, the height of a bar corresponding to a frequency channel may represent the signal strength of input received in a frequency channel. Accordingly, a bar having a greater height may have a stronger signal (e.g., contain less active interference) that a bar with a lower height. By presenting a display 300 that intuitively represents the interference and/or availability of channels in the channel space, a user is able to view the channel space state and, for example, may select an alternate frequency channel to perform the transmission of data to improve the reception and/or transmission of input to a wireless display device 101.

In further embodiments, display 300 also displays an indicator 303 indicating the current channel being used to transmit input displayed in the wireless display device 101.

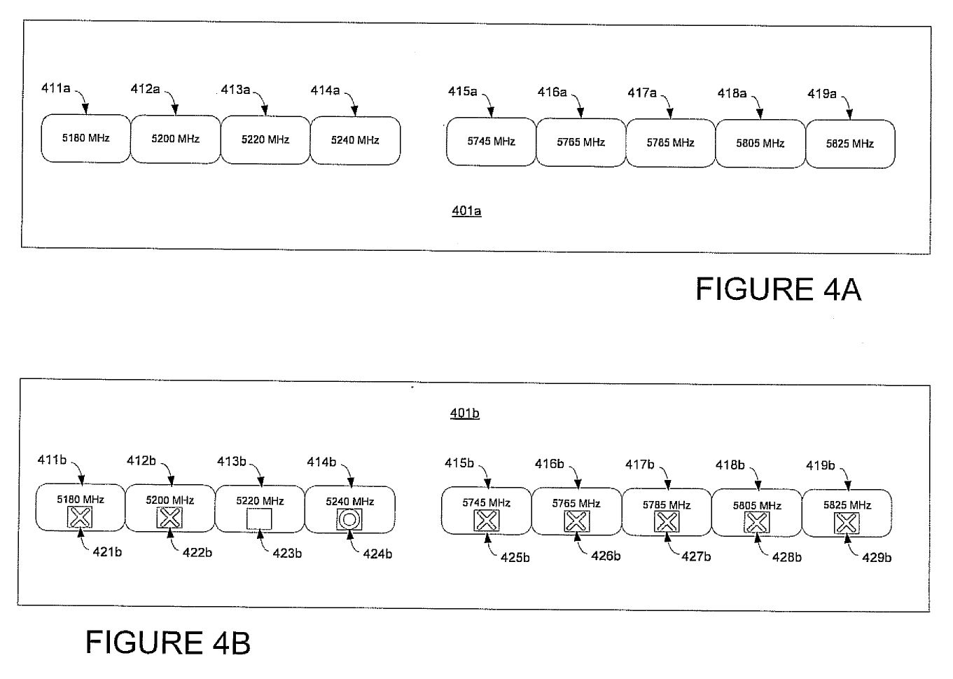

With reference now to FIGS. 4A and 4B, a graphical representation of an exemplary display 401a, 401b of channel occupancy in a channel space state is depicted, in accordance with embodiments of the present invention. Display 401a, 401b may, for example, comprise the graphical representation of the channel space state (e.g., graphical display 113, 211) displayed in a display device (e.g., wireless display device 101, flat-panel television 201) of FIGS. 1 and 2.

As depicted in FIG. 4A, display 401a comprises plurality of nodes (e.g., nodes 411a, 412a, 413a, 414a, 415a, 416a, 417a, 418a and 419a), each node representing a channel in the band of frequencies. In one embodiment, occupancy for the band of frequencies is distinguished by visible indicia. For example, available channels (e.g., unoccupied or relatively unoccupied channel) may be distinguished from unavailable channels (e.g., occupied or relatively occupied channels) by color (e.g., an available channel is presented in a color dissimilar to the color of an unavailable channel). For example, an unoccupied (or relatively unoccupied) node may be colored green, and an occupied (or relatively occupied) node may be colored red. According to another embodiment, the visible indicia may include, but are not limited to, the luminance of the node. For example, a darkened node may indicate an occupied node, whereas a brightly glowing node may indicate an unoccupied node.

As depicted in FIG. 4B, display 401b comprises plurality of nodes (e.g., nodes 411b, 412b, 413b, 414b, 415b, 416b, 417b, 418b and 419b), each node representing a channel in the band of frequencies. In one embodiment, occupancy for the band of frequencies is indicated according to a specific indicator (e.g., indicator 421b, 422b, 423b, 424b, 425b, 426b, 427b, 428b and 429b) corresponding to each node (e.g., indicator 421b corresponds to node 411b; indicator 422b corresponds to node 412b, etc. . . . ) As presented, an indicator (e.g., indicators 421b, 422b, etc.) may display specific icons representing the plurality of states. In one embodiment, the plurality of states includes a state for the current attuned frequency channel (e.g., a circle such as that displayed in indicator 424b), unoccupied and/or available frequency channels (e.g., a blank indicator, as displayed in indicator 423b) and occupied and/or unavailable frequency channels (e.g., a cross such as that displayed in indicator 421b, 422b, 425b, 426b, 427b, 428b and 429b). Other visible indicia may be employed according to various embodiments. For example, rather than indicator icons, indicators may display a flashing pattern which may indicate a level of occupancy, or a combination of visible indicia.

While specific examples of visible indicia have been presented with reference to FIGS. 4A and 4B, embodiments of the present invention are not thus limited and are well suited to other implementations.

### Detecting Interference in a Channel Space

With reference to FIG. 5, a flowchart of an exemplary computer-controlled process 500 performed in a transmitter unit 107 for automatically displaying channel space interference in a wireless display device is depicted, in accordance with various embodiments of the present invention. Process 500 may be performed by, for example, a transmitter unit 107 transmitting input over a frequency channel to a wireless display device 101. In alternate embodiments, process 500 may be performed in a plurality of transmitter units in combination with a plurality of wireless display devices.

At step 501 of FIG. 5, the channel space for a band of frequencies is automatically scanned to determine the state of the channel space. The channel space state may comprise, for example, the level of occupancy (e.g., detected interference) for each of the frequency channels in a band of frequencies. In one embodiment, a band of frequencies is the 2.4 GHz ISM band. In alternate embodiments, the band of frequencies is the 5.8 GHz ISM band. Accordingly, other bands may be used according to various embodiments. In one embodiment, scanning may comprise a spectral analysis of the radio frequency spectrum for the particular band of frequencies, by, for example, scanning each channel in the band in a pre-determined, sequential order. In some embodiments, the spectral analysis may be performed by, for example, a transceiving unit, such as the transmitter 107 described above with reference to FIG. 1. In further embodiments, the transceiving unit may wirelessly transmit data over a select frequency channel (“input frequency channel”) in the band of frequencies to a remotely positioned display device. In still further embodiments, scanning the band of frequencies may be performed continuously, or repeated after a pre-determined interval (e.g. 10 ms).

In one embodiment, once a scan of the channel space is performed, the transceiving unit 107 may store the data in a data structure, such as a table. In further embodiments, subsequent scans of the channel space automatically update the table accordingly. In alternate embodiments, the transmitter 107 may also scan the channel space once a pre-defined threshold of interference for the select frequency channel is surpassed. In still further embodiments, the transmitter 107 may also scan the channel space upon the election of the user.

At step 503, the channel space state is communicated to a display device 101 receiving input In one embodiment, communicating the channel space state to the display device 101 may comprise, for example, transmitting the data structure (e.g., the table of data) to the display device 101 over the select frequency channel. In further embodiments, the display device 101 may also comprise functionality to scan the channel space state. According to these embodiments, the channel space state may be communicated between the display device 101 and the transmitter 107 so as to synchronize the observed channel space state between both the display device 101 and the transmitter 107.

At step 505, the presence of interference in the channel space is determined from the scan of the channel space performed in step 501. If interference in the frequency channel used to transmit input between the transmitter 107 to the display device 101 is determined, the process proceeds to step 507. Otherwise, if interference in the frequency channel is not determined, the process repeats from steps 501 to 505. Interference may be detected by, for example, detecting a level of energy in a frequency corresponding to the input frequency channel. In one embodiment, interference is affirmatively detected when energy in a frequency corresponding to the input frequency channel surpasses a certain threshold. Alternatively, interference may be presumed when the transfer of data between the transmitter 107 and the receiver 111 is delayed or lost (e.g., expected data packets are not received).

At step 507, the existence of available (e.g., unoccupied) channels in the spectrum is determined. In one embodiment, if frequency channels are determined to be available, the process proceeds to step 509. If however, there are no available frequency channels with a detected spectral energy less than a pre-determined threshold (e.g., all frequency channels are substantially occupied), the process proceeds to step 511. In alternative embodiments, a user may be able to vary the conditions for proceeding to step 511 (displaying a graphical representation of the channel space). For example, a user may set a minimum threshold of available channels, wherein if less than the threshold of channels in the spectrum are detected, the process proceeds to step 511. Accordingly, a user may be provided notice when available channel space is rare or threatened through the display of the on-screen graphical representation 300, 401a, and 401b.

At step 509, the input channel is changed in response to interference detected in step 505. In one embodiment, the next available channel in the spectrum (according to a sequence) is automatically selected and used as the input channel (e.g., the channel used to communicate data between the transmitter 107 and the receiver 111). In alternative embodiments, the channel with the least amount of detected interference (according to a heuristic) may be selected and used as the input channel to transmit data. In an alternate embodiment, either the transmitter 107 or the receiver 111 selects an available channel in the spectrum to broadcast data. The other device scans the channel space to detect the channel communicating data from the broadcasting device and subsequently selects and uses the channel to communicate data with the broadcasting device.

At step 511, an on-screen graphical representation 300, 401a, 401b of the channel space state may be displayed in the display device 101, 201 when interference is detected in step 505. In one embodiment, on-screen graphical representation 300, 401a, 401b may be displayed whenever interference is detected in the current input channel. By displaying the channel space state in the display device 101, a user may alter the input frequency channel to another frequency channel with less detected interference. Accordingly, a user may use the displayed channel space state to designate another frequency as the input frequency, thereby advantageously reducing the level of interference in frequency channel used to transmit input displayed in the wireless display device 101. Alternatively, on-screen graphical representation 300, 401a, 401b may be displayed only when no available channels are detected (e.g., all channels are occupied). Accordingly, by displaying the channel space state in display device 101, a user is alerted to the presence of interfering devices, such as a microwave oven in operation or other wireless devices.

In one embodiment, the election of another frequency as the input frequency may be performed automatically according to a heuristic as described above with respect to step 509. For example, the frequency channel with the least amount of detected interference may be selected as the input frequency. In alternate embodiments, the election of another frequency as the input frequency may be performed by the user using a remote control unit 205. In still further embodiments, a user may be able to select a frequency channel manually, through a console or interface disposed on an external surface of the display device 101 and/or transmitter 107.

While the on-screen graphical representation 300, 401a and 401b is being displayed at step 511, the channel space is continuously scanned at step 513. Continuous scanning of the channel space may comprise, for example, steps 501 and 503 as described herein (scanning channel space and communicating channel space state, respectively).

While scanning is performed at step 513, the presence of an available (e.g., unoccupied channel) is determined at step 515. If an unoccupied channel is detected, the process proceeds directly step 517. Otherwise, steps 511 through 515 are repeated (e.g., an on-screen graphical representation is displayed with the channel space is continuously scanned) until an unoccupied channel is detected.

At step 517, the unoccupied channel detected in step 515 is elected to communicate data between the receiver 111 and the transmitter 107. In one embodiment, the first available channel determined in step 515 is automatically elected by the transmitter 107. Once the receiver 111 no longer receives data from the transmitter 107 from the channel previously used to communicate data, the receiver 111 will scan the channels in the channel space to detect the broadcast of data from the transmitter 107. Once the receiver 111 detects the broadcast of data from the transmitter 107 on the newly elected channel, the communication of data between the receiver 111 and the transmitter 107 may resume.

According to some embodiments, even after the communication of data between the receiver 111 and the transmitter 107 resumes on an otherwise unoccupied channel during step 517, the on-screen graphical representation 300, 401a, 401b may persist on the display device 101. By persisting for a duration of time, the user may be able to view the state of the channel space for diagnostic purposes. According to further embodiments, the duration of time the on-screen graphical representation 300, 401a, 401b persists may be pre-determined for a period of time (e.g., a threshold of 5 seconds).

In still further embodiments, while the on-screen graphical representation 300, 401a and 401b is displayed on the display device 101, a determination is made (e.g., at set intervals, or according to a counter) whether the display of the on-screen graphical representation 300, 401a, 401b has exceeded the pre-determined threshold. For example, if the threshold was set to 5 seconds, after the threshold is achieved, the process proceeds to step 523, where the display is removed. Otherwise, the process repeats the steps 519 and 521 until the threshold is achieved.

With reference to FIG. 6, a flowchart of an exemplary computer-controlled process 600 performed in a transmitter unit 107 for manually displaying channel space interference in a wireless display device is depicted, in accordance with various embodiments of the present invention. Process 600 may be performed by, for example, a transmitter unit 107 transmitting input over a frequency channel to a wireless display device 101. In alternate embodiments, process 600 may be performed in a plurality of transmitter units in combination with a plurality of wireless display devices.

At step 601 of FIG. 6, the channel space for a band of frequencies is automatically scanned to determine the state of the channel space. Step 601 may be performed as described with reference to step 501 of FIG. 5.

At step 603, the channel space state is communicated to a display device 101 receiving input Step 603 may be performed as described with reference to step 503 of FIG. 5.

At step 605, user-input communicating a request to display the on-screen graphical representation of the channel space state is received. Alternatively, if no user-input communicating such a request is received, step 501 and 503 are continuously repeated (e.g., periodically), while the transmitter 107 and the receiver 101 are in operation. The user-input may be communicated by a remote input device, such as a remote control 205. Alternatively, the user-input may be communicated through an interface on either the receiver 111 or the transmitter 107.

At step 607, once the user-input communicating a request to display the on-screen graphical representation of the channel space state is received in step 605, the channel space state is displayed as an on-screen graphical representation 300, 401a, 401b on display device 101.

While the on-screen graphical representation 300, 401a, 401b of the channel space state is displayed in step 607, the channel space is continuously scanned at step 609. Continuously scanning the channel space may be performed by the combination of steps 601 and 603, as described above. When modifications to the channel space are determined in step 609, the on-screen graphical representation 300, 401a, 401b is updated to correspond.

In one embodiment, the on-screen graphical representation 300, 401a, 401b displaying in the display device 101 is displayed until the user-input communicating a request to remove the display is received at step 611. As in step 605, the user-input may be communicated by a remote input device, such as a remote control 205. Alternatively, the user-input may be communicated through an interface on either the receiver 111 or the transmitter 107. Once the user-input communicating a request to remove the display is received in step 611, the display is removed (e.g., no longer displayed in the display device at step 613, while scanning of the channel space (e.g., steps 601 and 603) continues.

### Scanning Channel Space

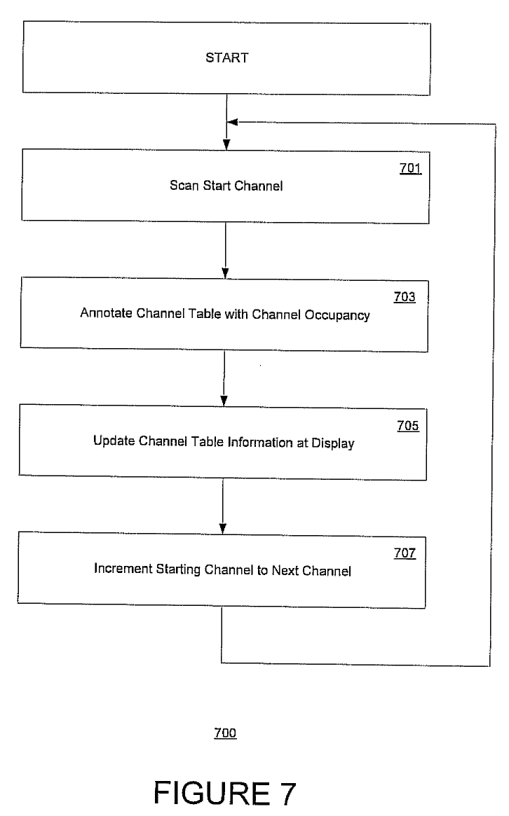

With reference to FIG. 7, a flowchart of an exemplary computer-controlled process 700 for scanning a channel space state is depicted, in accordance with various embodiments of the present invention. In one embodiment, process 700 may be performed as, for example, step 501 of FIG. 5.

At step 701, a starting channel in the channel space is scanned for occupancy (e.g., interference). In one embodiment, the starting channel may be a default, pre-selected channel. According to other embodiments, the starting channel may be the channel currently used by the receiver 111 to receive input communicated wirelessly from the transmitter 107.

At step 703, the scan of the starting channel performed in step 701 is analyzed to determine the occupancy of the starting channel. The availability (e.g., occupancy) of the starting channel is noted in a channel table.

At step 705, a data structure communicatively coupled to the display 101 is updated to incorporate the channel table annotated in step 703. In one embodiment, the data structure comprises a data table corresponding to the channels in the channel space. The data structure may be stored in, for example, local memory in a wireless device (e.g., transmitter 107 and receiver 111).

At step 707, the starting channel is incremented to the next channel in the spectrum, and process 700 is repeated. The next channel may be, for example, the next channel in a pre-determined sequential order (e.g., in order of ascending/descending frequencies). The process 700 may be performed for each channel in the channel space continuously, or at pre-determined intervals.

### Displaying Channel Space State in a Wireless Display Device

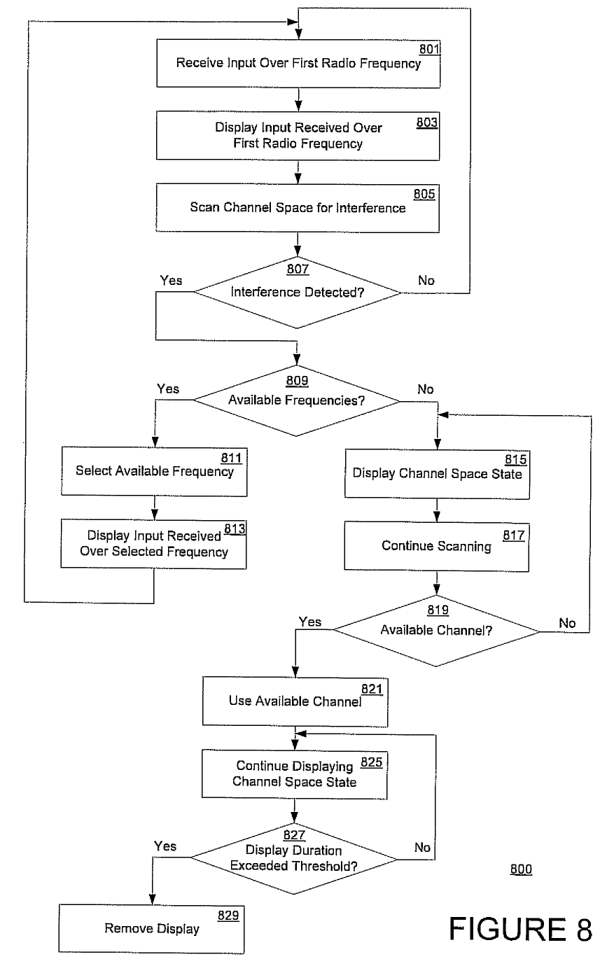

With reference to FIG. 8, a flowchart of an exemplary computer-controlled process 800 for automatically displaying a channel space state in a wireless display device is depicted, in accordance with various embodiments of the present invention. Process 800 may be performed by, for example, a display device 101 receiving input over a frequency channel from a transmitter 107. In alternate embodiments, process 800 may be performed in a plurality of receiver devices in combination with a plurality of transmitter devices.

At step 801, input is received in a display device 101 over a first channel frequency. In one embodiment, the channel frequency comprises a first radio frequency in a band of frequencies. The input may comprise, for example, a plurality of available channels from a cable or satellite television service converted to a radio frequency signal on a single channel and transmitted over an input frequency by a transmitter 107, remotely positioned from the display device 101. In one embodiment, the input is received in a receiver unit 111 communicatively coupled to the display device 101.

At step 803, the input received by receiving unit 111 over the first channel frequency is displayed in display device 101.

At step 805, the channel space is scanned for interference. In one embodiment, scanning the channel space may be performed according to the process 700 as described above with reference to FIG. 7.

At step 807, the scan of the channel space performed at step 805 is evaluated to determine interference in the first channel frequency. If interference is detected in the first channel frequency, the process proceeds to step 809. If, however, no interference is detected, steps 801 through 807 may be performed continuously (e.g., periodically at pre-determined intervals) while display device 101 and transmitter 107 are in operation.

At step 809, the existence of available (e.g., unoccupied) channels in the spectrum is determined. The availability of frequencies in the spectrum may be determined as described with reference to step 507 of process 500. In one embodiment, if frequency channels are determined to be available, the process proceeds to step 811. If however, there are no available frequency channels with a detected spectral energy less than a pre-determined threshold (e.g., all frequency channels are substantially occupied), the process proceeds to step 815.

At step 811, the input frequency is changed in response to interference detected in step 807. In one embodiment, the next available frequency in the spectrum (according to a sequence) is automatically selected and used as the input frequency. In alternative embodiments, the frequency with the least amount of detected interference (according to a heuristic) may be selected and used as the input frequency to transmit data. In one embodiment, the receiver 111 selects an available channel in the spectrum to broadcast data. The transmitter 107, after detecting that the receiver 111 is no longer receiving and/or communicating over the first radio frequency, scans the channel space to detect the frequency communicating data from the broadcasting receiver 111 and subsequently selects and uses the channel to communicate data with the receiver 111.

At step 813, input from the transmitter 107 received over the selected frequency is displayed in the display device 101.

At step 815, an on-screen graphical representation 300, 401a, 401b of the channel space state may be displayed in the display device 101, 201 when interference is detected in step 807. In one embodiment, on-screen graphical representation 300, 401a, 401b may be displayed when no or substantially few available channels are detected (e.g., all channels are occupied). By displaying the channel space state in the display device 101, a user is thus alerted to the presence of interfering devices, such as a microwave oven in operation or other wireless devices.

While the on-screen graphical representation 300, 401a and 401b is being displayed at step 815, the channel space is continuously scanned at step 817. Continuous scanning of the channel space may comprise, for example, scanning the channel space for interference as provided in step 803 and described with reference to the process 700.

While scanning is performed at step 817, the presence of an available (e.g., unoccupied channel) is determined at step 819. If an unoccupied channel is detected, the process proceeds directly step 821. Otherwise, steps 815 through 819 are repeated (e.g., an on-screen graphical representation is displayed with the channel space is continuously scanned) until an unoccupied channel is detected.

At step 821, the unoccupied channel detected in step 819 is selected to communicate data between the receiver 111 and the transmitter 107. In one embodiment, the first available channel determined in step 819 is automatically elected by the receiver 111. Once the transmitter 107 detects the broadcast of data from the receiver 111 on the newly elected channel, the communication of data between the receiver 111 and the transmitter 107 resumes.

According to some embodiments, even after the communication of data between the receiver 111 and the transmitter 107 resumes on an otherwise unoccupied channel during step 821, the on-screen graphical representation 300, 401a, 401b may persist on the display device 101. By persisting for a pre-determined duration of time, the user may be able to view the state of the channel space for diagnostic purposes. According to further embodiments, the duration of time the on-screen graphical representation 300, 401a, 401b persists may be pre-determined for a period of time (e.g., a threshold of 5 seconds).

In still further embodiments, while the on-screen graphical representation 300, 401a and 401b is displayed on the display device 101, a determination is made (e.g., at set intervals, or according to a counter) whether the display of the on-screen graphical representation 300, 401a, 401b has exceeded the pre-determined threshold. After the threshold is achieved, the process proceeds to step 829, where the display is removed. Otherwise, the process repeats the steps 825 and 827 until the threshold is achieved.

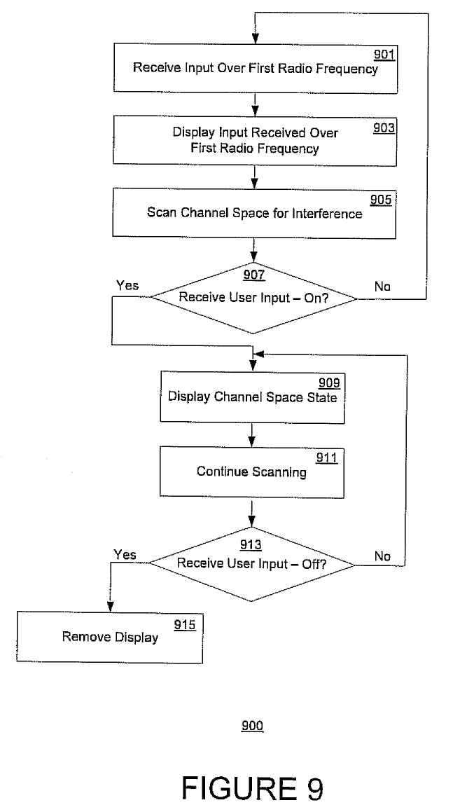

With reference to FIG. 9, a flowchart of an exemplary computer-controlled process 900 for manually displaying a channel space state in a wireless display device is depicted, in accordance with various embodiments of the present invention. Process 900 may be performed by, for example, a display device 101 receiving input over a frequency channel from a transmitter 107. In alternate embodiments, process 900 may be performed in a plurality of receiver devices in combination with a plurality of transmitter devices.

At step 901, input is received in a display device 101 over a first channel frequency. Step 901 may be performed as described with reference to step 801 of FIG. 8.

At step 903, the input received by receiving unit 111 over the first channel frequency is displayed in display device 101.

At step 905 of FIG. 6, the channel space for a band of frequencies is automatically scanned to determine the state of the channel space. Step 905 may be performed as described with reference to process 700 of FIG. 7.

At step 907, user-input communicating a request to display the on-screen graphical representation of the channel space state is received. Alternatively, if no user-input communicating such a request is received, steps 901 through 905 are continuously repeated (e.g., periodically), while the transmitter 107 and the receiver 101 are in operation. The user-input may be communicated by a remote input device, such as a remote control 205. Alternatively, the user-input may be communicated through an interface on either the receiver 111 or the transmitter 107.

At step 909, once the user-input communicating a request to display the on-screen graphical representation of the channel space state is received in step 907, the channel space state is displayed as an on-screen graphical representation 300, 401a, 401b on display device 101.

While the on-screen graphical representation 300, 401a, 401b of the channel space state is displayed in step 909, the channel space is continuously scanned at step 911. Continuously scanning the channel space may be performed according to the process 700, as described above with reference to FIG. 7. When modifications to the channel space are determined in step 911, the on-screen graphical representation 300, 401a, 401b is updated to correspond.

In one embodiment, the on-screen graphical representation 300, 401a, 401b displaying in the display device 101 is displayed until the user-input communicating a request to remove the display is received at step 913. As in step 907, the user-input may be communicated by a remote input device, such as a remote control 205. Alternatively, the user-input may be communicated through an interface on either the receiver 111 or the transmitter 107. Once the user-input communicating a request to remove the display is received in step 913, the display is removed (e.g., no longer displayed in the display device at step 915, while scanning of the channel space (e.g., steps 601 and 603) continues.

Although the subject matter has been described in language specific to structural features and/or processological acts, it is to be understood that the subject matter defined in the appended claims is not necessarily limited to the specific features or acts described above. Rather, the specific features and acts described above are disclosed as example forms of implementing the claims.

What is claimed is:

1. A method for detecting signals in a channel space and display thereof, the method comprising:
scanning a plurality of channels comprising a channel space to determine a channel space state, said channel space state comprising signal occupancy of said plurality of channels;
communicating said channel space state to a wireless display device, said wireless display device receiving input over a first channel of said channel space;
determining interference in said first channel of said channel space; and
displaying, in said wireless display device, a graphical representation of said channel space state in response to interference determined in said first channel, wherein said scanning is performed in a transmitter.

2. The method according to claim 1, wherein said plurality of channels comprises a band of radio frequencies.

3. The method according to claim 1, wherein said transmitter is remotely positioned from said wireless display device.

4. The method according to claim 3, further comprising:
selecting a second channel comprising an unoccupied channel from said plurality of channels in said channel space; and
automatically receiving, in said wireless display device, input over a second channel of said channel space.

5. The method according to claim 4, wherein said selecting said second channel is performed automatically wherein said second channel comprises a level of interference less than a level of interference comprised in said first channel.

6. The method according to claim 4, wherein said selecting said second channel comprises:
receiving a user-generated input, said input comprising a selection of an unoccupied channel in said channel space.

7. The method according to claim 6, wherein said user-generated input is transmitted to said transmitter via a remote control.

8. The method according to claim 1, wherein scanning a channel in said plurality of channels comprises
designating a channel as a starting channel, said starting channel comprising a channel in said channel space;
scanning a starting channel for interference in said starting channel;
annotating a channel table to record said interference in said starting channel;
updating a channel table comprised in said wireless display device; and
incrementing said starting channel to a next channel in a pre-determined scanning order.

9. The method according to claim 9, wherein said scanning said plurality of channels is performed at pre-determined intervals.

10. A method for displaying a channel space state in a wireless display device, the method comprising:
receiving, in a wireless display device, an input over a first radio frequency in a band of radio frequencies of a channel space;
displaying said input received over said first radio frequency in said wireless display device;
scanning said band of radio frequencies comprising said channel space to determine a channel space state, said channel space state comprising signal occupancy of said band of radio frequencies;
communicating said channel space state to said wireless display device;
determining interference in said first raid frequency of said channel space; and
displaying, in said wireless display device, a graphical representation of said channel space state in response to interference determined in said first radio frequency, wherein said scanning is performed in a receiver.

11. The method according to claim 10, further comprising:
terminating said displaying said input from said first frequency in said wireless display device;
selecting a second radio frequency comprising an unoccupied radio frequency in said channel space; and
displaying said input received from a transmitter over said second radio frequency in said wireless display device.

12. The method according to claim 11, wherein said selecting said second radio frequency is performed automatically when interference is detected in said first radio frequency.

13. The method according to claim 12, wherein said selecting said second radio frequency comprises receiving a user-generated input, said input comprising a selection of an unoccupied radio frequency in said channel space.

14. The method according to claim 10, wherein said generating a channel space state comprises scanning said channel space for channel space data, said channel space data corresponding to a plurality of radio frequencies in said band of radio frequencies.

15. A system for displaying channel usage of a space state in a wireless display device, the system comprising:
a receiver operable to be communicatively coupled to a transmitter, for receiving content transmitted over a first radio frequency, said first radio frequency in a band of radio frequencies of said channel space; and
a wireless display device communicatively coupled to said receiver and for displaying said content received by said receiver;
wherein a graphical representation of said usage of said channel space is displayed in said wireless display device.

16. The system according to claim 14, wherein said graphical representation of said usage of said channel space comprises a plurality of occupied radio frequencies, a plurality of unoccupied radio frequencies and said first radio frequency of said channel space.

17. The system according to claim 15, wherein said graphical representation further comprises visible indicia identifying said plurality of occupied radio frequencies, said plurality of unoccupied radio frequencies and said first radio frequency.

18. The system according to claim 15, wherein said visible indicia comprises a plurality of distinguishing colors.

19. The system according to claim 14, wherein said graphical representation of said channel space comprises a level of interference detected for said band of radio frequencies.

20. The system according to claim 14, wherein said wireless display device comprises a flat-panel television.
